(19) United States
(12) Patent Application Publication
(10) Pub. No.: US 2008/0087527 A1
(43) Pub. Date: Apr. 17, 2008

(54) Process belt for transporting a good through a process space, more preferably for forming a nonwoven and usage of such a process belt

(75) Inventors: Frank Esser, Duren (DE); Kurt Widdau, Hurthgenwald (DE); Kurt Sullot, Nettetal (DE)

Correspondence Address: COLLARD & ROE, P.C., 1077 NORTHERN BOULEVARD, ROSLYN, NY, 11576, US

(73) Assignee: GKD - Gebr. Kufferath AG

(21) Appl. No.: 11/901,799

(22) Filed: Sep. 19, 2007

Related U.S. Application Data
(60) Provisional application No. 60/853,742, filed on Oct. 23, 2006.

(30) Foreign Application Priority Data
Oct. 12, 2006 (DE) 10 2006 048 747.8

(51) Int. Cl. B65G 15/30

(52) U.S. Cl. 198/844.1

(57) ABSTRACT

With a process belt, more preferably for the forming of a nonwoven, electrostatic charges can be safely prevented if a mixed fabric with a metal component and a plastic component is used as process belt. The metal and plastic components are interwoven with one another.

The invention relates to a process belt for the transporting of a good through a process space, more preferably for the forming of a nonwoven with a fabric structure and the usage of such a process belt.

In the industry process belts are used everyday in large number. A very well known application form is a process belt for the transporting of nonwoven fibres through an oven, wherein the fibres which lie on the process belt are point-joined with one another in the oven, for example through heat, however, alternatively also through point-welding or point-gluing for example. At a discharge side of the machine the finished nonwoven can be taken from the process belt.

In modern production processes fabric belts are frequently employed. Here the belt structure is formed through a fabric structure, i.e. with warps and wefts.

Some of the process belts are very large. They can easily be present in orders of magnitude of 8 m wide and 160 m long or more. Plastics are therefore preferably employed for the fabric structure. These render such a process belt relatively cost-effective.

Since the good to be transported through the transport space is often susceptible to electrostatic charging or such can be caused on a plastic process belt there is however an increased working risk when using plastic belts. For example arc-like voltage discharges can occur which, especially with plastic belts, brings about a major fire hazard.

The invention is based on the object of making available an improved process belt.

This object is solved by a process belt for the transporting of a good to be subjected to a process through a process space, more preferably for the forming of a nonwoven, with a fabric structure and with a formation of the fabric as mixed fabric with a plastic component and with a metal component for the prevention of electrostatic charging.

Advantageously the mixed fabric makes possible a compromise between cost-effective manufacture through as high as possible a plastic component which is nonetheless occupationally safe as a result of electrostatic discharge via the metal component.

The metal component of the mixed fabric is preferably led to a surface of the process belt. If the metal component is led up to the surface of the process belt, i.e. more preferably to the surface of the belt on which the good to be transported is to rest, there is automatically a direct contact between the good and the metal conductor. With such a design the metal component need merely be suitably earthed towards the rear and any static charge in the contact region of such a metal conductor can be safely excluded.

It is proposed that the metal component has a metal warp. With process belts of the type under consideration here the warp is generally provided in the circulating direction of the process belt. This makes it possible even with only a single warp to integrate a very great length of the metal conductor in the process belt. In addition, the meandering form of a warp results in a high probability of coming in direct contact with the good to be transported.

Independent of the provision of a metal warp it is proposed that the metal component has a metal weft. A metal wire for example can very easily be introduced in the fabric as weft. Such a wire also has a stabilizing effect for the fabric and rearward earthing can easily be connected to a metal weft.

More preferably it is proposed that the metal component has metal warps and metal wefts so that a conductor net is formed in the fabric. Such a design embodies the basic thought of the present invention in an ideal manner. Thus, the clearly predominant part of the material for the process belt can be chosen from plastics. At the same time even the provision of metal warps and metal wefts alone provides for a net of conductors that can be as tight as desired so that only quite small surface areas remain in which a good to be transported has no connection to a conductor. The overall area in which an electrostatic charge can usually form is multiply subdivided through the conductive warps and wefts in longitudinal and transverse direction.

The remaining surfaces from which electrostatic charges have to be transported can be designed very uniformly and economically if the conductor net has right-angled connections. In this case the intermediate areas are obtained as rectangles.

So that the plastic component of the process belt can be manufactured highly cost-effectively and yet is thermally or mechanically strong and easy to handle it is proposed that the plastic component has polyester, polyamide, polyethylene, polypropylene, PPS (polyphenylene sulphide) and/or PEEK (polyether etherketon). These materials have proved to be particularly suitable during experiments of the inventors.

For particularly good discharge results more preferably in the manufacture of nonwovens it is proposed that the fabric has a double layer with the metal component on an upper side and an underside of the process belt.

The metal component is preferably visibly integrated in the process belt fabric, more preferably through a surface colour which is different from that of the plastic component. For example the plastic can be present in blue-colored warps and/or threads which is a proven colour for process belts of this type. The metal wires, threads or strands are preferably left in their metal colour, for example in bronze colour. An operator on the plant thus immediately recognizes that it is an electrostatically earthed plant. In addition, earthing on the initial construction of the plant is easier to establish.

According to a second aspect of the invention the said object is solved by the use of a process belt with the characteristics described above for the transporting of a good to be subjected to a process through a process space, more preferably for forming a nonwoven, and for preventing harmful electrostatic charging.

In the following the invention is explained in more detail by means of exemplary embodiments making reference to the drawing. There it shows

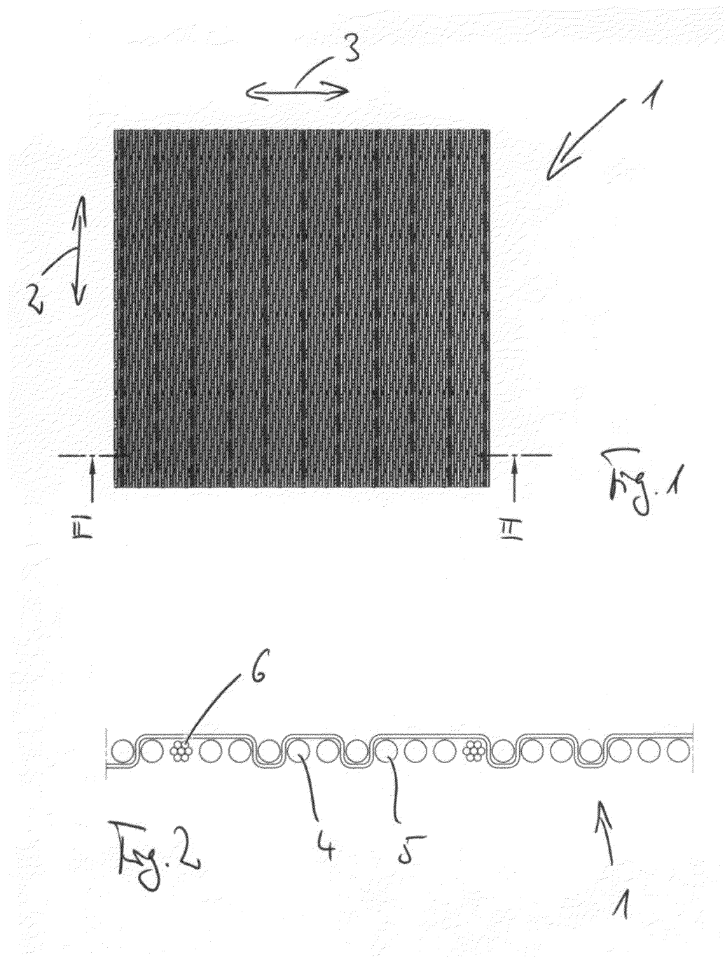

FIG. 1 schematically a top view of a process belt and

FIG. 2 schematically a section through the process belt from FIG. 1 according to the marking II-II there.

The process belt 1 presented in a cutout in the FIGS. 1 and 2 is manufactured from a fabric. Accordingly it has a warp direction 2 and a weft direction 3.

As wefts the fabric predominantly has monofilament plastic wires (exemplarily marked with 4, 5). The warps are likewise at least predominantly formed of monofilament plastic threads.

In this fabric manufactured predominantly of plastic, conductive metal wires or metal strands are integrated, namely as wefts (exemplarily numbered with 6) in form of metal strands and as warps, likewise in form of metal wires or metal strands.

Both the warps and also the wefts and in fact both the conductive as well as the non-conductive ones in each case, can be designed as monofilament or multifilament depending on the utilization purpose. In this way a discharge capability of electric charges which fulfills the requirements for equipment group 2 can be easily achieved with suitable dimensioning. With prototypes of process belts very low electric resistances were often achieved.

A mixed fabric of polyester with woven-in bronze threads has proved itself as a cost-effective, robust and high-conductance mixture of the materials during tests of the inventors. The process belts more preferably can be manufactured as single-layer or two-layer, wherein a double-layer construction more preferably makes possible a smooth surface and a non-marking pin seam. In addition, metal conductors can also be present on the fabric underside with double-layer fabrics.

Plain-weave single-layer fabrics have proved themselves as linear screen especially in the drylaid method during experiments of the inventors. More preferably the twill-weave single-layer construction with non-marking pin seam has proved itself as a stable laydown belt.

The fabric design makes possible an air permeability which is adapted to the process. The inventors have successfully tested numerous prototypes with an air permeability of 500 cfm to 900 cfm.

The inventors see an ideal utilization possibility of the proposed process belt in the homogenous nonwoven formation and optimum nonwoven removal.

Depending on the requirements on the process belt some warps or wefts of plastic can be replaced in a regular fabric through such of metal. Alternatively it can be considered to add additional wires in the fabric loops to an evenly constructed fabric of plastic.

For special applications a fabric may be suitable where synthetic wires are provided in running direction as warps and weft wires of metal. Such a fabric construction combines transverse stability with flexibility.

Since the transport belts are often provided for thermal processes it is proposed that the belt can pass through temperatures of more than 80° C. up to more than 300° C. without damage. High mechanical stability can additionally be advantageous for subsequent cleaning of the transport belts for example through brushing or water jet cleaning plants.

Next to every approximately fifteenth warp of monofilament plastic wire a particularly preferred prototype has a bronze wire co-woven in as warp, while next to approximately every sixteenth monofilament plastic weft wire a bronze wire is likewise co-woven in. With an exemplary ratio of a process belt the metal warp wires are located at a distance of approximately 1 cm to each other while the metal wefts have a distance of approximately 2 cm to each other.

1. A process belt (1) for the transporting of a good to be subjected to a process through a process space, more preferably for forming a nonwoven, with a fabric structure (2, 3), comprising a formation of fabric as mixed fabric with a plastic component and with a metal component for preventing electrostatic charging.

2. The process belt according to claim 1, wherein the metal component is led to a surface of the process belt.

3. The process belt according to claim 1, wherein the metal component has a metal warp.

4. The process belt according to claim 1, wherein the metal component has a metal weft.

5. The process belt according to claim 1, wherein the metal component has metal warps and wefts so that a conductor net is formed in the fabric.

6. The process belt according to claim 5, wherein the conductor net has rectangular connections.

7. The process belt according to claim 1, wherein the plastic component has polyester, polyamide, polyethylene, polypropylene, polyphenylene sulphide and/or PEEK (polyether etherketon).

8. The process belt according to claim 1, wherein the fabric has a double layer with a metal component on an upper side and an underside.

9. The process belt according to claim 1, wherein the metal component is visibly integrated in the fabric, more preferably through a surface color which is different from that of the plastic component.

10. Use of a process belt according to claim 1 for transporting a good to be subjected to a process through a process space, more preferably for the forming of a nonwoven.
